(19) United States
(12) Patent Application Publication
(10) Pub. No.: US 2016/0288486 A1
(43) Pub. Date: Oct. 6, 2016

(54) AUTOMATIC INK CARTRIDGE DISPENSER

(71) Applicant: Sonoco Development Inc., Hartsville, SC (US)

(72) Inventor: Clyde B. Gore, Hartsville, SC (US)

(21) Appl. No.: 14/675,195

(22) Filed: Mar. 31, 2015

(51) Int. Cl. B41F 31/13

(52) U.S. Cl. CPC B41F 31/13

(57) ABSTRACT

A method of dispensing ink that includes installing a cartridge having an ink-filled chamber into the dispenser of a web fed or a sheet fed offset printing press, with the chamber being defined by a tubular body, a fitment at a dispensing end having an outlet port closed by a valve, and a plunger slidably disposed in the open end of the tubular body opposite the dispensing end. The method includes weighing the cartridge in situ with a weighing device positioned within the ink dispenser to determine an initial weight of the cartridge prior to dispensing ink, dispensing ink from the cartridge throughout the print job, and weighing the cartridge in situ to determine an ending weight of the cartridge prior to removal from the ink dispenser. The ending weight is then subtracted from the initial weight to determine the weight of the ink dispensed during the print job.

### FIELD OF THE INVENTION

The present invention relates generally to ink management systems for printing presses, and more specifically to automatic ink cartridge dispensers for dispensing ink into the fountains of offset printing presses.

### SUMMARY

Briefly described, one embodiment of the present disclosure comprises a method of dispensing ink that includes installing a cartridge having a ink-filled chamber into an ink dispenser of a printing press, in which the chamber of the cartridge is defined by a tubular body, a fitment at a dispensing end having one or more outlet ports closed by a valve, and a plunger that is slidably disposed in a open end of the tubular body opposite the dispensing end. The cartridge is then weighed in situ with a weighing device that is positioned within the ink dispenser to determine an initial weight of the cartridge, prior to dispensing ink from the cartridge. The method further includes dispensing ink from the cartridge during a print job until the print job is complete or until the cartridge is substantially empty, and then again weighing the cartridge in situ with the weighing device to determine an ending weight of the cartridge prior to removing the cartridge. The method further includes subtracting the ending weight from the initial weight to determine the weight of the ink dispensed into the printing press during the print job.

In accordance with another embodiment, a system for dispensing ink into the fountain of a printing press that includes one or more ink cartridges, with each ink cartridge having a ink chamber defined by a tubular body, a fitment at a dispensing end having one or more outlet ports closed by valve, and a plunger that is slidably disposed in an open end of the tubular body opposite the dispensing end. The system further includes an ink dispenser positioned above the fountain of the printing press and having a receptacle that is adapted for removably receiving one of the ink cartridges. The receptacle of the ink dispenser further includes a weighing device at a lower end and a power cylinder that is mechanically coupled to a pusher plate at an upper end. The cartridge is received within the receptacle with the dispensing end supported on the weighing device for in situ weighing of the cartridge and any ink contained therein, and with the pusher plate becoming engaged with the plunger through the open end of the cartridge.

The invention will be better understood upon review of the detailed description set forth below taken in conjunction with the accompanying drawing figures, which are briefly described as follows.

### BRIEF DESCRIPTION OF THE DRAWINGS

FIG. 1 is a schematic perspective view of an ink dispensing system installed above a printing press, in accordance with a representative embodiment of the present disclosure.

FIGS. 2A and 2B are perspective end and exploded views of an ink cartridge for use in the ink dispensing system of FIG. 1.

FIG. 3 is a perspective, cut-away view of an ink dispenser and powering apparatus of the ink dispensing system of FIG. 1.

FIG. 4 is a schematic diagram of the pneumatic system for powering the ink dispensing system of FIG. 1.

Those skilled in the art will appreciate and understand that, according to common practice, various features of the drawings discussed below are not necessarily drawn to scale, and that dimensions of various features and elements of the drawings may be expanded or reduced to more clearly illustrate the embodiments of the present invention described herein.

### DETAILED DESCRIPTION

The present disclosure relates to a system and one or more methods for dispensing ink into a printing press, and particularly into the fountain of a web-fed or a sheet-fed offset printing press. The system and methods generally include means for in situ determination of the weight of ink dispensed into the fountain during the print job. As described in more detail below, the ink dispensing system and methods disclosed herein can provide several significant advantages and benefits over other types of ink dispensers or methods for providing ink to a printing device. However, the recited advantages are not meant to be limiting in any way, as one skilled in the art will appreciate that other advantages may also be realized upon practicing the present disclosure.

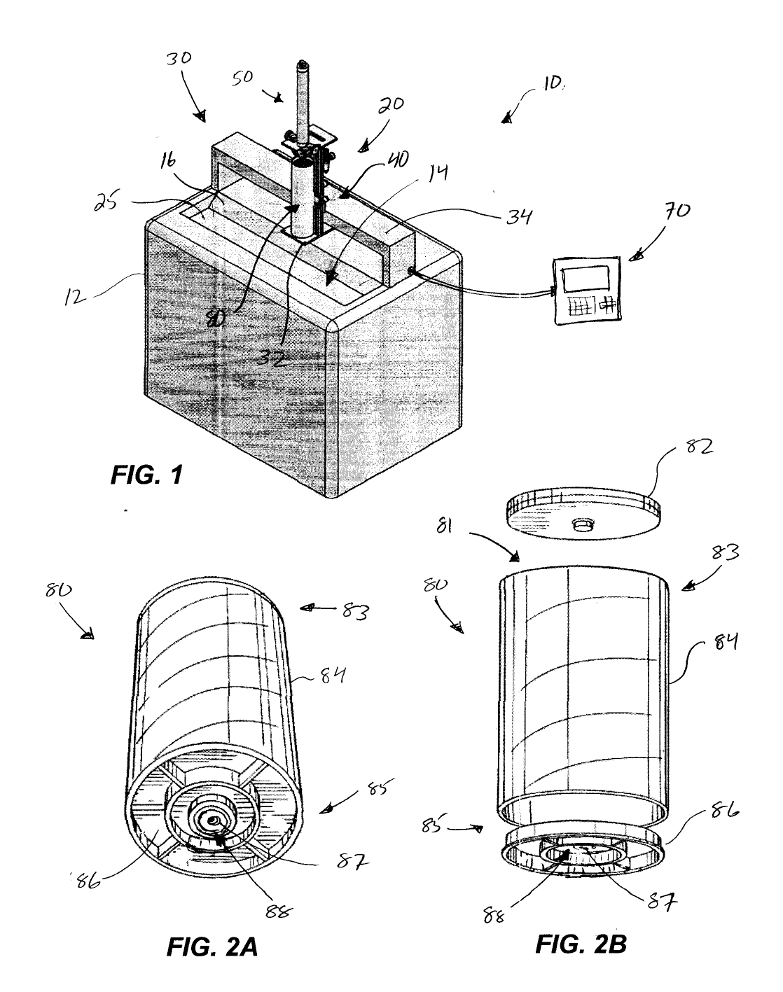

Referring now in more detail to the drawing figures, wherein like features are identified with like reference numerals throughout the several views, FIG. 1 schematically illustrates one representative embodiment of a system 20 for dispensing ink into a printing press 10, and more specifically for dispensing ink 25 into the reservoir or fountain 14 of an offset printing press station 12 or unit. During operation of the printing press 10 the ink 25 in the fountain 14 is taken up by a fountain roller 16 which then transfers the ink, through a series of rollers and/or cylinders (not shown but known to one of skill in the art) onto a printable media, such as a paper-based web or sheet, as it is carried through a lower portion the printing press station 12. Since any particular station 12 of the offset printing press 10 generally only applies one color of ink onto the printable media, the printing press 10 typically includes multiple additional printing press stations (also not shown) that are aligned together in series, with each printing press station applying a different color of ink sequentially to the printable media to form the final printed product. In addition, the rates at which ink 25 is taken up by the fountain rollers 16 can independently vary across the printing press stations 12, in accordance with the color pattern that is applied to the printable media. Accordingly, each of the offset printing press stations 12 generally includes its own ink dispensing system 20 for maintaining a desired amount of ink 25 within the fountain 14 throughout a print job.

The ink dispensing system 20 includes an ink dispenser 40 that is configured to removably receive a cartridge 80 containing the ink 25. As shown in FIG. 1, the ink dispenser 40 can be mounted to a translatable carriage 32 that forms a portion of a positioning system 30. The positioning system 30 can also include a support beam 34 mounted above the top of the printing press station 12, with the carriage 32 and ink dispenser 40 being moved back and forth along the support beam 34 via a controllable actuation system (not shown but know in the art) across the width of the fountain 14. It is contemplated, however, that other types of positioning systems for moving the ink dispenser 40 over the open fountain 14, such as an articulated robotic arm, are also possible and considered to fall within the scope of the present disclosure. The motion of the ink dispenser 40 and carriage 32 can be controlled by an electronic control device 70 for the ink dispensing system 20 which is in electrical communication with the positioning system 30.

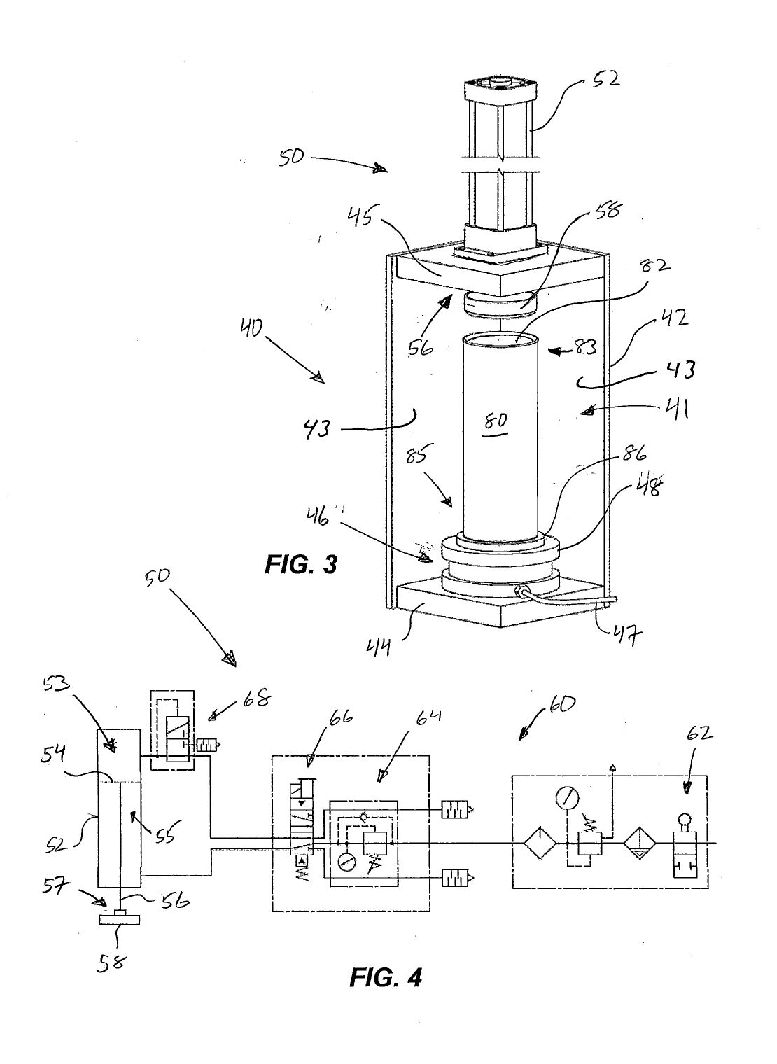

The ink dispensing system 20 also includes a powering apparatus 50 for driving the dispensing of ink 25 from the cartridge 80. As shown FIGS. 3 and 4, in one aspect the powering apparatus 50 can include a pneumatic driver, such as a pneumatic power cylinder 52 housing a piston 54 and a piston rod 56, and with the distal end 57 of the piston rod 56 being connected to a pusher plate 58 that directly or mechanically engages with the plunger 88 that defines the upper end of the ink cavity 81.

The ink 25 within the fountain 14 commonly is viscous such that the level of the ink 25 in the fountain becomes drawn down locally at various places across the width of the fountain and the fountain roller 16, in accordance with the differing ink demands of the pattern being transferred to the printable media. To better distribute the ink 25 to the locations that need it most, in some aspects the ink dispensing system 20 can further include one or more sensors (not shown) for sensing and monitoring the level of ink 25 across the width of the fountain 14, and which are in electrical communication with the electronic control device 70 that is configured to activated the ink dispensing 40 when it is positioned over a low spot. As the control device 70 for operating the positioning system 30, for monitoring the level of the ink 25 in the fountain 14, and for activating the ink dispenser 40 at the appropriate time is generally known in the art, it will not be discussed further except for how it may be integrated or combined with the improved system and method for dispensing ink that is disclosed herein.

As shown in FIGS. 2A and 2B, the cartridge 80 generally comprises a tubular core or body 84 having a cylindrical sidewall 85 formed from a rigid material, such a recycled paper or recycled paperboard, and in which the inner surface of the sidewall 85 has been treated or coated with a non-absorbing and optionally low-friction material to contain the ink stored therein. The tubular body 84 has a dispensing end 87 sealed by a dispensing fitment 86 that is rigidly secured to the lower edge of the sidewall 85, and a plunger end 83 sealed by a plunger 82 that slides against the inner surfaces of the sidewalls 85 in response to a force applied by the powering system 50. The variable volume circumscribed by the sidewalls 85, the dispensing fitment 86, and the plunger 82 defines a fluid-tight chamber 81 for containing the ink. As discussed in more detail below, the cartridge 80 is not limited to one particular size or set of dimensions. Indeed, the cartridge 80 can be provided in a variety of standardized lengths and diameters so as to contain a number of different predetermined quantities of ink within the fluid-tight chamber 81.

The dispensing fitment 86 includes one or more outlet ports 87 closed a valve 88, such as a spring-loaded one-way valve. The outlet port 87/valve 88 can be centered within the fitment 86 and configured to automatically open in response to an increase in the pressure within the cartridge 80 above a predetermined threshold. In one aspect the profiles of the interior surfaces of the plunger 82 and the dispensing fitment 86 can be matched to minimize any empty space between the two surfaces once the plunger has been pushed all the way down to the dispensing end 87, so as to minimize any residual amount of ink that remains within the cartridge 80 after its removal from the ink dispenser 40.

FIG. 3 is a perspective, cut-away view of the ink dispenser 40 and powering apparatus 50 of the ink dispensing system 20, which may also be known as an automatic ink cartridge dispenser. The ink dispenser 40 includes a vertically aligned receptacle 41 that is generally defined by a casing 42 having sidewalls 43, a bottom plate 44 at a lower end, and a top plate 45 at an upper end. The receptacle 41 further includes a load cell 46 or similar micro-scale/weight measurement device mounted to the bottom plate 44. The load cell 46 can communicate with the electronic control device 70 (FIG. 1) via a power and communications cable 47. An adapter plate 44 can be mounted on top the load cell 46 and configured to removably receive the dispensing end 87 of the cartridge 80. In one aspect either the receptacle 41, the adapter plate 44, or both can be configured to receive cartridges 80 of different sizes or shapes, such as a plurality of standardized lengths or diameters for ink cartridges known in the industry. In addition, each of the bottom plate 44, the load cell 46, and the adapter plate 48 can have an aperture that aligns together with the other apertures below the outlet port 87 and valve 88 of the dispensing fitment 86, so as to allow for the passage of the ink from the cartridge 80 into the fountain of the printing press unit.

Once a cartridge 80 has been installed within the receptacle 41, the load cell 46 can be used to measure its weight in situ at various times during one or more printing cycles or print jobs, including but not limited to (a) before the beginning of ink dispensing and (b) after the completion of ink dispensing, such as when the cartridge is emptied of ink or the print job is completed. In this manner the total weight of the ink, or ink weight, dispensed into the fountain during the printing cycle or print job can be directly and accurately determined while the cartridge remains installed into the receptacle 41. In turn, the ink weight can be applied by the operator of the printing press or the supplier of the ink to accurately quantify the cost of the ink that was used in a particular printing cycle or print job.

The ability to determine the ink weight accurately and directly while the cartridge 80 is installed within the ink dispenser 40 can be a significant advantage over existing methods for determining the cost of the ink dispensed during a printing cycle or a print job. For instance, existing methods for determining ink weight generally rely on a calculation that is based on the volume of the dispensed ink and its specific gravity. However, the specific gravity of inks can vary widely depending on their type, color, manufacturer, and the like, while a precise value for the volume of the ink dispensed into the fountain using existing pneumatic-drive ink dispensers is also difficult to determine. Thus, using existing volume-based technologies and methods to obtain an accurate value for the ink weight at each printing press station, especially during a print job that applies multiple colors to the printed media, can be problematic.

Directly measuring the weight of the dispensed ink in situ, or while the cartridge 80 is installed within the receptacle 41 of the ink dispenser 40, can be especially useful in print jobs that dispense only a partial amount of the ink from the cartridge 80 during a print job, such that a portion of usable ink remains in the cartridge after the print job is complete. If desired, this process can allow the user to leave the cartridge 80 within the ink dispenser 40 until the next print job is started, at which point the partially-filled cartridge is again weighed before the beginning of ink dispensing and after the completion of ink dispensing, and the value for the ink weight dispensed into the fountain for the new printing cycle can be applied to the new print job. Alternatively, the partially-filled cartridge can be removed for storage and/or later use on a subsequent print job that calls for the same ink, with the initial amount of ink weight being easily determined without regard to the specific gravity of the ink or the size of the cartridge. The ink dispensing system 20 and its method of use can thus facilitate the usage of partially-filed and/or previously-used ink cartridges in a more efficient manner.

The powering system 50 for mechanically pushing or driving the slidable plunger located in the upper end of the upright cartridge 80 can be installed above the top plate 45 of the receptacle 41. In one aspect the powering system 50 can include a pneumatic power cylinder 52 supported above the receptacle 41 with a piston rod assembly extending downward through an aperture in the top plate 45. The piston rod assembly can comprise the piston 54 within the power cylinder 52, a piston rod 56, and a pusher plate 58 that is attached to the distal end 57 of the piston rod 56 and configured to engage with the outer surface of the plunger 82. In one aspect the pusher plate 58 can be removable or interchangeable with pusher plates having different sizes and/or shapes, so as to better connect with cartridges having plungers with different sizes and/or shapes.

As shown in FIG. 4, the powering system 50 can also include a pneumatic circuit 60 comprising a plurality of components such as an air supply 62, a pressure regulator 64, and a valve assembly 66 that is in fluid communication with the pneumatic power cylinder 52. In one aspect the pneumatic circuit 60 can also include a quick exhaust valve 68 that allows the compressed air acting on the forward side 53 of the piston 54 to be quickly released to ambience, thereby releasing any pressure on the plunger and cartridge by the pusher plate 58. In addition, the powering system 50, including the pressure regulator 64, can be placed in electrical communication with and operated by the same electronic control device 70 (FIG. 1) that senses and monitors the level of the ink in the fountain and that controls the movement of ink dispenser 40 along the positioning system 30.

When the cartridge 80 is first installed into the receptacle 41 with the dispensing end 87 supported upon the adapter plate 44, the cartridge 80 can be held in a centered and upright position by one or more support brackets or fixtures (not shown but known in the art). Once the cartridge 80 is supported within the receptacle 41, the load cell 46 can be activated or queried to measure an initial weight of the cartridge 80 and to provide that signal or data (depending on the type of electronics included within the circuitry of the load cell 46) to the electronic control device 70 via communications cable 47. It is understood that the initial weight measured by the load cell 46 generally comprises the weight of both the empty cartridge 80 and the ink 25 contained therein.

Once the initial weight of the cartridge 80 has been determined, the pneumatic circuit 60 can be activated to direct compressed air into the forward end 53 of the power cylinder 52, thereby pushing the piston rod 56 downward until the pusher plate 58 engages with the plunger 82. In one aspect the powering system may be configured so that that pusher plate 58 only lightly engages the plunger 82 on its initial contact, and without sufficient force to increase the pressure within the ink chamber above the pressure threshold that would cause the valve 88 in the outlet port 87 of the dispensing fitment 86 to open. The quick release valve 68 in the pneumatic circuit 60 can then be opened to release the compressed air within the forward end 53 of the power cylinder 52, leaving only the empty weight of the piston rod assembly pressing down on the plunger 82. Alternatively, the pressure regulator 64 can be operated to open the valve assembly 66 and simultaneously release the pressure within both the forward end 53 and the return end 55 of the pneumatic power cylinder 52, so as to allow the piston rod assembly to drop down under its own weight to engage the plunger 80.

At this point the load cell 46 may be activated or queried again to take a combined weight measurement of the cartridge weight, ink weight, and dead weight of the piston rod assembly. If the weight of the empty cartridge is known, and if the dead weight of the piston rod assembly is also known or can be determined by subtracting the initial weight from the first combined weight measurement, subsequent combined weight measurements can then be used to estimate and/or monitor the amount of ink remaining within the ink cavity 81 of the cartridge 80 throughout the printing cycle. Generally, in this step either the quick release valve 68 and/or the valve assembly 66 would be opened to ambience to release any compressed air with the power cylinder 52 prior to the measurement that would affect is accuracy in either the heavier or the lighter directions.

To dispense ink from the cartridge 80, such as when a sensor detects a localized low spot in the level of ink 25 with the fountain 14 (FIG. 1), a signal can be sent from the electronic control device 70 to the pressure regulator 64 to direct compress air into the forward end 53 of the pneumatic power cylinder 52 to drive the pusher plate 58 downward against the top of the plunger 82. Because the pusher plate 58 is mechanically linked to the piston rod 56, the alignment of the pusher plate against the top surface of the plunger 82 can remain straight and centered throughout the stroke of the piston rod assembly. Accordingly, the orientation of the plunger cab be constrained as it is pushed directly downward through the tubular core 84 or the cartridge 80 without tilting or cocking or otherwise becoming misaligned. The powering system 50 can further include a measurement device for measuring the vertical position of the pusher plate 58 and/or piston 54 as further indication of the amount of ink within the cartridge.

The ink in the cartridge 80 will generally be dispensed at intermittent intervals during the print job or printing cycle, as indicated by the ink level sensor and monitored by the electronic control device 70. When the powering system 50 is activated to apply pressure to the plunger 82, the increase in pressure within the ink cavity 81 can be sensed as increased weight by the load cell 46. If the ink 25 has the characteristics of an incompressible fluid, the pressure (or weight) will rise near instantaneously until it reaches the release pressure for the spring-loaded valve 88 that opens to allow ink to flow through the outlet port 87 into the fountain of the printing press station.

After the opening of the valve 88, the continued pressure applied by the powering system 50 can further affect the rate at which ink is dispensed. For example, if the ink cavity pressure is maintained near the release pressure of the valve 88, the ink can be dispensed at a low or moderate flow rate as determined by the size of the outlet port aperture. If the ink cavity pressure rises substantially above the release pressure of the valve, however, the ink can be dispensed at a much faster rate. In one aspect of the disclosure, the output of the load cell can monitored throughout the dispensing cycle as an indirect measurement of the dispensing rate and/or amount of ink that is dispensed into the fountain. If desired, the output of the load cell can further be applied in a control loop that feeds back to the powering system 50 to adjust the pressure applied by the power cylinder 52, with the pressure being continuously adjusted to control the flow of ink from the cartridge.

When the desired amount of ink has been deposited into the fountain, the powering system 50 can be deactivated and the pressure within the ink cavity 81 allowed to drop back below the release pressure of the valve 88, which automatically closes to stop the flow of ink. In one aspect of the ink dispensing system, the quick release valve 68 can again be opened to release the compressed air within the forward end 53 of the power cylinder 52, and another intermediate combined weight measurement of the cartridge weight, ink weight, and dead weight of the piston rod assembly can again be captured to estimate the amount of ink remaining within the cartridge 80. If desired, the electronic control device 70 may be programmed to compare the difference between combined weight measurements before and after a dispensing cycle against the indirect measurement of the dispensing rate during the dispensing cycle to ensure that the dispensing system is operating accurately.

Accordingly, the weight or amount of the ink in the ink cavity can be continuously monitored throughout the printing cycle using one or more of the methods described above. As the container approaches an empty condition, the electronic control device 70 can be programmed to notify the operator of the printing press of the anticipated depletion of the cartridge, and provide the operator with one or more options. For example, if the operator determines that the print job is nearly complete and the ink currently deposited within the fountain is sufficient to finish the printing cycle, the operator may choose to disable the ink dispensing system 20 from dispensing any more ink for the remainder of the print job. Alternatively, if the operator determines that remaining ink in the cartridge together with the ink currently deposited within the fountain will be sufficient to complete the print job, the operator can elect to let the normal printing cycle continue through to completion with the installed printing cartridge. In yet another embodiment the operator may determine that the remaining ink in the cartridge together with the ink currently deposited within the fountain will be insufficient to complete the print job, in which case the operator can activate the electronic control device 70 to manually dispense the remaining ink in the cartridge prior to its normal emptying time, thereby giving the operator additional time to remove and replace the used cartridge with another cartridge, whether new or previously used, having sufficient ink contained therein to complete or extend the printing cycle until the print job is complete.

After completion of the dispensing, such as when the cartridge is emptied of ink or the print job is completed, the valve assembly 66 in the pneumatic circuit 60 can be controlled by the pressure regulator 64 to release the pressure within the forward end 53 of the pneumatic power cylinder 52 and to direct compressed air into the return end 55, thereby raising the piston rod assembly back to its initial position and withdrawing pusher plate 58 from the tubular body 84 of the cartridge 80. The load cell 46 can be then activated or queried to measure the ending weight of the cartridge 80 prior to its removal from the receptacle 41 of the ink dispenser 40. Whether the cartridge 80 is empty or still partially filled with ink, the electronic control device 70 can be programmed to subtract the in-situ measurements of the ending weight of the cartridge 80 from its initial weight to accurately and directly determine the weight of the ink that was dispensed into the fountain 24 of the printing press unit 22 during a printing cycle. Furthermore, if multiple cartridges and printing cycles are used during a particular print job, the electronic control device 70 can be programed to track and combine the weight of the ink dispensed from each cartridge to determine the total dispensed ink weight.

With reference back to FIG. 1, it will be appreciated that the electronic control device 70 can be located on or adjacent to the printing press unit 22 or can be removed to a remote location. In addition, the electronic control devices for each printing press unit on a printing pressed can be networked together or to a stand-along master computer or control device that monitors and control each of the local control devices. Alternatively, in other aspects the electronic control devices can be combined together into a single control device for the entire printing press 20, with individual modules of the control device being dedicated to monitor and control each ink dispensing system. Other control and networking configuration are also possible and considered to fall within the scope of the present disclosure.

The ink dispensing system and methods of the present disclosure been described herein in terms of preferred embodiments and methodologies considered by the inventor to represent the best mode of carrying out the invention. It will be understood by the skilled artisan, however, that a wide range of additions, deletions, and modifications, both subtle and gross, may be made to the illustrated and exemplary embodiments of the composite sheet without departing from the spirit and scope of the invention. For example, the powering system can be activated to lift the piston rod assembly off the top face of the plunger prior to intermediate measurements of the cartridge and ink weight during a printing cycle, or the pneumatic system can be replaced with an electrical system which utilizes linear motors or servo-motors and a drive rod or drive screw to engage the pusher plate with the top face of the plunger. These and other revisions might be made by those of skill in the art without departing from the spirit and scope of the invention that is constrained only by the following claims.

1. A method of calculating the amount of ink used in a printing press during a print job, the method comprising:
removably installing a cartridge having a chamber containing ink into an ink dispenser of a printing press, the chamber being defined by a tubular body, a fitment at a dispensing end having a least one outlet port closed by a valve, and a plunger slidably disposed in a open end opposite the dispensing end;
prior to dispensing ink from the cartridge, weighing the cartridge in situ to determine an initial weight of the cartridge containing a first quantity of ink;
dispensing ink from the cartridge during a print job until the print job is complete;
prior to removing the cartridge, weighing the cartridge in situ to determine a ending weight of the cartridge containing a second quantity of ink; and
subtracting the ending weight from the initial weight to determine the weight of the ink dispensed into the printing press during the print job.

2. The method of claim 1, further comprising weighing the cartridge in situ with a load cell.

3. The method of claim 1, further comprising weighing the cartridge in situ with a weighing device positioned within a lower end of the ink dispenser.

4. The method of claim 3, wherein the weighing device includes an annular shape with a center aperture adapted to align with the outlet port in the fitment.

5. The method of claim 1, wherein the valve further comprises a pre-loaded valve configured to seal the chamber against a chamber pressure that is less than a valve release pressure, and wherein dispensing ink further comprises pressing a pusher plate against the plunger through the open end of the cartridge to raise the pressure of the ink within the chamber above the valve release pressure.

6. The method of claim 5, wherein the pusher plate is mechanically coupled to and driven by a piston rod extending from a power cylinder.

7. The method of claim 6, wherein the power cylinder is pneumatically powered.

8. The method of claim 6, further comprising weighing the cartridge in situ to determine the initial weight prior to engaging the pusher plate with the plunger.

9. The method of claim 6, further comprising disengaging the pusher plate from the plunger prior to weighing the cartridge to determine the ending weight.

10. The method of claim 5, further comprising intermittently dispensing ink from the cartridge by alternatingly activating the power cylinder to increase the chamber pressure above the valve release pressure, and then allowing the chamber pressure to decline back toward the valve release pressure as ink is dispensed until the valve closes.

11. The method of claim 10, further comprising weighing the cartridge in situ prior to or after intermittently dispensing ink from the ink cartridge to determine an intermediate combined weight, wherein the intermediate combined weight comprises an intermediate quantity of ink and the dead weight of the pusher plate, the piston and the piston rod.

12. A system for dispensing ink into the fountain of a printing press, the system comprising:
at least one cartridge having a chamber containing ink, the chamber being defined by a tubular body, a fitment at a dispensing end having a least one outlet port closed by a valve, and a plunger slidably disposed in a open end opposite the dispensing end; and
an ink dispenser of a printing press, the ink dispenser including a receptacle having a lower end, an upper end, and being adapted for removably receiving the at least one cartridge, the receptacle including a weighing device at the lower end configured for in situ weighing of the cartridge, and a power cylinder mechanically coupled to a pusher plate at the upper end,
wherein the cartridge is received in the receptacle with the dispensing end supported on the weighing device and the pusher plate engaged with the plunger through the open end of the cartridge.

13. The system of claim 12, wherein the valve further comprises a pre-loaded valve configured to seal the chamber against a chamber pressure that is less than a valve release pressure.

14. The system of claim 12, wherein the weighing device includes an annular shape with a center aperture adapted to align with the outlet port the fitment.

15. The system of claim 12, wherein the weighting device further comprises a load cell.

16. The system of claim 12, further comprising an adapter plate supported on the weighing device and configured to receive the distal end of the cartridge.

17. The system of claim 16, wherein the adapter plate is configured to receive cartridges of different size.

18. The system of claim 12, wherein the power cylinder is pneumatically powered.

19. The system of claim 12, wherein the printing press a web fed or a sheet fed offset printing press.

20. The method of claim 1 comprising the further step of:
when the print job is complete, removing the cartridge so the ink in the cartridge can be used in a new print job.

21. The method of claim 1 comprising the further step of:
having the electronic control device notify the operator of the anticipated depletion of the cartridge, thereby providing the operator the option to:
(i) disable the ink dispensing system if the ink currently deposited in the fountain is sufficient to finish the print job;
(ii) allow the system to continuing dispensing ink from the cartridge if the ink in the cartridge and in the fountain is sufficient to finish the print job; or
(iii) activate the electronic control device to manually dispense the remaining ink in the cartridge prior to its normal dispensing time to give the operator time to remove and replace the cartridge if the ink in the cartridge and in the fountain is insufficient to finish the print job.
